(19) United States
(12) Patent Application Publication
(10) Pub. No.: US 2023/0155102 A1
(43) Pub. Date: May 18, 2023

(54) ELECTRODE MANUFACTURING APPARATUS

(71) Applicant: Toyota Jidosha Kabushiki Kaisha, Toyota-shi (JP)

(72) Inventors: Tetsuya Mimura, Chiryu-shi (JP); Yusuke Kintsu, Miyoshi-shi (JP); Haruka Shionoya, Toyota-shi (JP); Takeshi Kondo, Kariya-shi (JP); Yuta Kawamoto, Kariya-shi (JP)

(73) Assignee: Toyota Jidosha Kabushiki Kaisha, Toyota-shi (JP)

(21) Appl. No.: 17/895,415

(22) Filed: Aug. 25, 2022

(30) Foreign Application Priority Data
Nov. 15, 2021 (JP) 2021-185891

(51) Int. Cl. H01M 4/04; B05C 1/08; B05C 1/00; H01M 10/0585

(52) U.S. Cl. CPC H01M 4/0409; B05C 1/0808; B05C 1/0873; B05C 1/0865; B05C 1/003; H01M 4/0404; H01M 10/0585; H01M 4/0435

(57) ABSTRACT

An electrode manufacturing apparatus includes a shaping roll and an opposed roll that sandwich an electrode therebetween and rotate in opposite directions, and a temperature adjusting unit. The temperature adjusting unit reduces a temperature difference between a central portion and an end portion in an axial direction, of at least one roll of the shaping roll and the opposed roll.

### CROSS-REFERENCE TO RELATED APPLICATION

This application claims priority to Japanese Patent Application No. 2021-185891 filed on Nov. 15, 2021, incorporated herein by reference in its entirety.

### BACKGROUND

### 1. Technical Field

The disclosure relates to an electrode manufacturing apparatus.

### 2. Description of Related Art

Japanese Unexamined Patent Application Publication No. 2002-015764 (JP 2002-015764 A) describes a battery including positive and negative electrodes each having electrode active material layers on opposite surfaces of a current collector plate, in which grooves are formed in the electrode active material layers of either the positive or negative electrode.

### SUMMARY

When large-area batteries are manufactured by an apparatus described in JP 2002-015764 A, it is difficult to maintain the uniformity of the groove depth in the width direction.

The disclosure proposes an electrode manufacturing apparatus capable of maintaining the uniformity of the groove depth of an electrode.

According to the disclosure, an electrode manufacturing apparatus including a pair of rolls that sandwich an electrode and rotate in opposite directions, and a temperature adjusting unit, is proposed. The temperature adjusting unit is configured to reduce a temperature difference between a central portion and an end portion in an axial direction, of at least one roll of the pair of rolls.

With the temperature adjusting unit thus configured to reduce the temperature difference between the central portion and the end portion of the roll, the uniformity of the thermal expansion between the central portion and the end portion of the roll can be improved, and the uniformity of the outside diameter of the roll between the central portion and the end portion of the roll can be improved. Accordingly, the uniformity of the groove depth of the electrode in the width direction can be maintained.

In the above electrode manufacturing apparatus, the electrode may have a substrate and an electrode layer formed on a surface of the substrate, and the pair of rolls may have a shaping roll configured to form an uneven shape on a surface of the electrode layer, and an opposed roll that is opposed to the shaping roll such that the electrode is sandwiched between the shaping roll and the opposed roll. By adjusting the temperature of at least one roll of the shaping roll and the opposed roll, the uniformity of the groove depth of the electrode in the width direction can be maintained.

In the above electrode manufacturing apparatus, the shaping roll may be configured to form recesses in a form of grooves extending in a width direction of the electrode, in the surface of the electrode layer. The recesses extending in the width direction of the electrode give flexibility to the electrode, so that cracking of the electrode layer during conveyance of the electrode can be curbed.

In the above electrode manufacturing apparatus, the shaping roll may be configured to form the recesses extending over an entire length of the electrode layer in the width direction. The recesses communicate with the opposite edges of the electrode layer in the width direction, and liquid can flow in the recesses, so that the penetration time in the subsequent electrolyte injection process can be reduced.

In the above electrode manufacturing apparatus, the temperature adjusting unit may be configured to adjust a temperature of the opposed roll. By adjusting the temperature of the opposed roll, it is possible to efficiently maintain the uniformity of the groove depth of the electrode in the width direction.

In the above electrode manufacturing apparatus, the temperature adjusting unit may have a cooling device that cools the end portion. With this arrangement, the temperature difference between the central portion and the end portion of the roll can be reliably reduced.

In the above electrode manufacturing apparatus, the temperature adjusting unit may have a heating device that heats the central portion. With this arrangement, the temperature difference between the central portion and the end portion of the roll can be reliably reduced.

The above electrode manufacturing apparatus may further include temperature sensors that detect a temperature of the central portion and the temperature of the end portion. The temperature adjusting unit can efficiently reduce the temperature difference between the central portion and the end portion of the roll, based on the temperature difference between the central portion and the end portion of the roll.

According to the electrode manufacturing apparatus of the disclosure, even when large-area batteries are manufactured, the uniformity of the groove depth of the electrode can be maintained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing the configuration of a first example of an electrode in an embodiment;

FIG. 2 is a perspective view schematically showing the configuration of a second example of the electrode in the embodiment;

FIG. 3 is a perspective view schematically showing the configuration of a third example of the electrode in the embodiment;

FIG. 4 is a conceptual diagram showing an electrode manufacturing apparatus according to the embodiment;

FIG. 5 is a conceptual diagram showing details of the configuration of a film forming device;

FIG. 6 is a conceptual, perspective view showing details of the configuration of the film forming device;

FIG. 7 is a schematic view showing a first example of a temperature adjusting unit;

FIG. 8 is a schematic view showing a second example of the temperature adjusting unit;

FIG. 9 is a graph showing the temperature difference and the groove depth difference between a central portion and end portions of a roll in a comparative example; and

FIG. 10 is a graph showing the temperature difference and the groove depth difference between a central portion and end portions of a roll in an example.

### DETAILED DESCRIPTION OF EMBODIMENTS

One embodiment will be described based on the drawings. In the following description, the same reference signs are assigned to the same components. The names and functions of these components are identical. Thus, detailed description of the components will not be repeated.

### Electrode 100

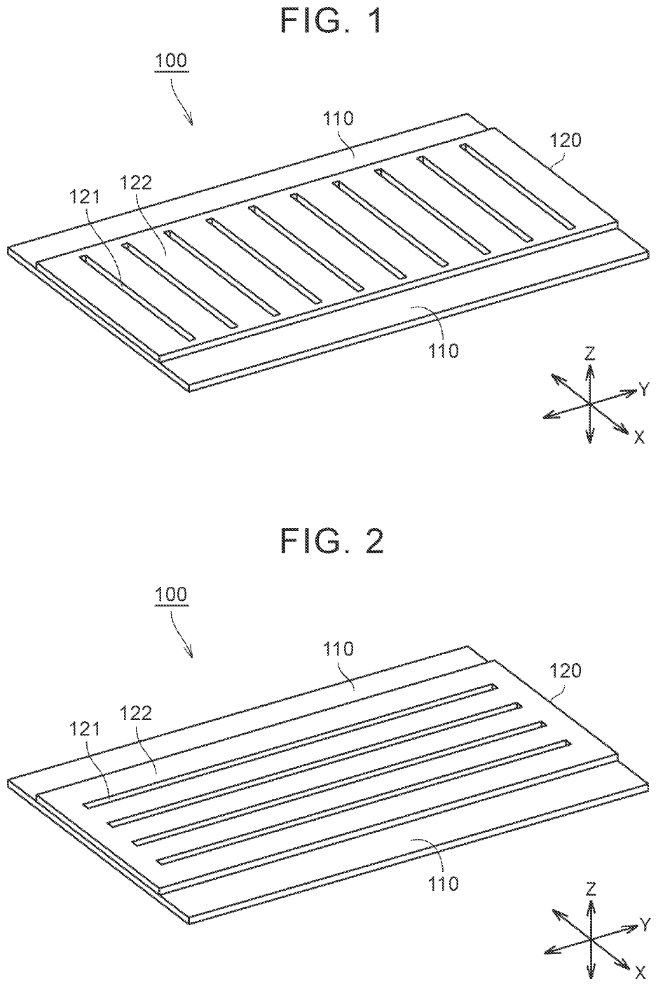

FIG. 1 is a perspective view schematically showing the configuration of a first example of an electrode 100 in the embodiment. The electrode 100 is used, for example, as an electrode of a lithium-ion secondary battery (non-aqueous electrolyte secondary battery). The lithium-ion secondary battery can be used, for example, as a power supply of a hybrid electric vehicle (HEV), battery electric vehicle (BEV), plug-in hybrid electric vehicle (PHEV), or the like. However, the electrode 100 of this disclosure is not limited to such automotive applications, but can be applied to any use.

As shown in FIG. 1, the electrode 100 has a substrate 110 and an electrode layer 120. The substrate 110 is a support for the electrode layer 120. The substrate 110 may be in the form of a sheet, for example. The substrate 110 may be in the form of a strip, for example. The substrate 110 may have electrical conductivity. The substrate 110 may function as a current collector. The substrate 110 may include, for example, a metal foil. When the electrode 100 is a positive electrode, the substrate 110 may include, for example, an aluminum foil. When the electrode 100 is a negative electrode, the substrate 110 may include, for example, a copper foil.

The electrode layer 120 is formed on a surface of the substrate 110. The electrode layer 120 may be formed on only one surface of the substrate 110 as shown in FIG. 1, or may be formed on both the front and back surfaces of the substrate 110.

The electrode layer 120 is an electrode active material layer containing electrode active material. The electrode active material may be a positive-electrode active material or a negative-electrode active material. The positive-electrode active material may be selected from, for example, lithium-containing metal oxides, lithium-containing phosphates, etc. The negative-electrode active material may be selected from, for example, carbon-based negative-electrode active materials such as graphite, easily graphitizable carbon, and non-graphitizable carbon, and alloy-based negative-electrode active materials containing silicon, tin, etc.

Recesses 121 (grooves) are formed in the electrode layer 120. At least one recess 121 is formed in the electrode layer 120. The recess 121 has any cross-sectional shape. The bottom of the recess 121 may be flat, curved, or inclined. The recess 121 may be U-shaped or V-shaped in cross-section. Raised portions 122 are formed between adjacent ones of the recesses 121.

The electrode 100 has a long-side or longitudinal direction (Y-direction) and a short-side direction (X-direction). The longitudinal direction corresponds to the conveying direction in the manufacturing process of the electrode 100. The short-side direction is perpendicular to the longitudinal direction, and may also be referred to as the “width direction” of the electrode 100. The electrode 100 also has a thickness direction (Z-direction). The thickness direction is perpendicular to the XY plane. The recess 121 is formed such that a part of the electrode layer 120 is recessed from the surface of the electrode layer 120, to extend in the Z-direction.

In the example shown in FIG. 1, the recesses 121 and the raised portions 122 extend in the short-side direction. The recesses 121 are formed at equal intervals in the longitudinal direction. The groove-like recesses 121 extending in the short-side direction of the electrode 100 are formed in the electrode layer 120, to give flexibility to the electrode 100. Thus, cracking of the electrode layer 120 during conveyance of the electrode 100 is curbed, and the conveyability of the electrode 100 is improved.

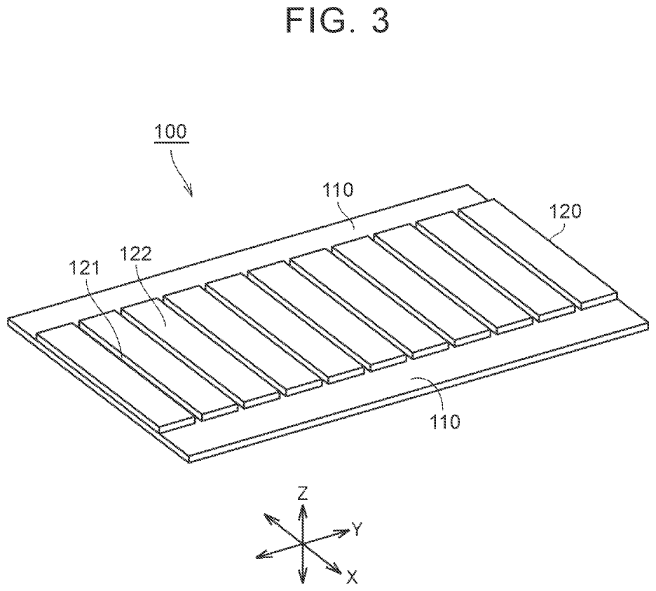

FIG. 2 is a perspective view schematically showing the configuration of a second example of the electrode 100 in the embodiment. In the example shown in FIG. 2, the recesses 121 and the raised portions 122 extend in the longitudinal direction. The recesses 121 are formed at equal intervals in the width direction. The recesses 121 extending in the longitudinal direction of the electrode 100 are formed in the electrode layer 120, to reduce the difference in the amount of shrinkage between the substrate 110 and the electrode layer 120 during drying. Thus, warpage of the electrode 100 after drying is curbed.

FIG. 3 is a perspective view schematically showing the configuration of a third example of the electrode 100 in the embodiment. In the example shown in FIG. 3, the recesses 121 extend in the width direction of the electrode 100 as in the example of FIG. 1, and extend over the entire length of the electrode layer 120 in the width direction. The recesses 121 extending continuously from one edge to the other edge of the electrode layer 120 in the width direction are formed, so as to give flexibility to the electrode 100, and reduce the penetration time in the subsequent electrolyte injection process because the recesses 121 communicate with the opposite edges of the electrode layer 120 in the width direction, thus allowing liquid to flow in the recesses 121.

The electrode 100 may have both the recesses 121 and raised portions 122 extending in the longitudinal direction as shown in FIG. 2, and the recesses 121 and raised portions 122 extending in the short-side direction as shown in FIG. 1 and FIG. 3. The shape of each of the recesses 121 is not limited to the straight line shown in FIG. 1 to FIG. 3, but may be curved, wavy, or dotted. The planar pattern of the recesses 121 may be a set of numerous parallel lines or a grid.

### Electrode Manufacturing Apparatus 1

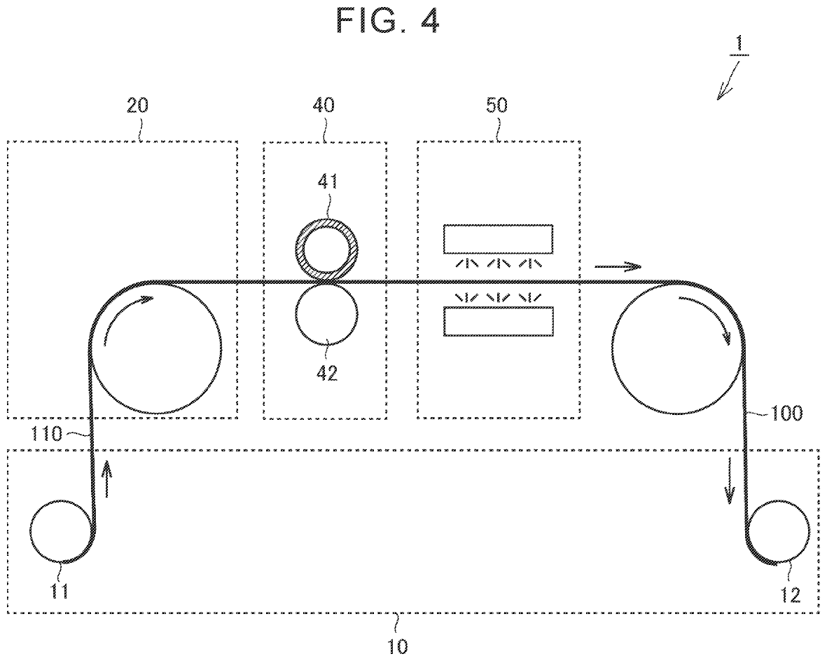

FIG. 4 is a conceptual diagram showing the electrode manufacturing apparatus 1 according to the embodiment. As shown in FIG. 4, the electrode manufacturing apparatus 1 includes a conveyor device 10, film forming device 20, shaping device 40, and drying device 50.

The conveyor device 10 has a feed roll 11 and a take-up roll 12. The feed roll 11 is formed such that the substrate 110 is wound around its core material. The substrate 110 is rolled out from the feed roll 11. The take-up roll 12 takes up the substrate 110 (electrode 100). The conveyor device 10 conveys the substrate 110 such that it passes through the film forming device 20, shaping device 40, and drying device 50 in this order, and conveys the electrode 100 as a laminate formed by laminating the electrode layer 120 on the substrate 110.

The film forming device 20 forms the electrode layer 120 on the surface of the substrate 110. Details of the film forming device 20 will be described later.

The shaping device 40 forms an uneven shape on the surface of the electrode layer 120. The shaping device 40 forms the recesses 121 and the raised portions 122 in the electrode layer 120. The shaping device 40 has a shaping roll 41 and an opposed roll 42, for example. The shaping roll 41 and the opposed roll 42 constitute a pair of rolls that rotate in opposite directions while sandwiching the electrode 100 therebetween. The shaping roll 41 forms the uneven shape on the surface of the electrode layer 120. The opposed roll 42 is opposed to the shaping roll 41 with the electrode 100 sandwiched therebetween.

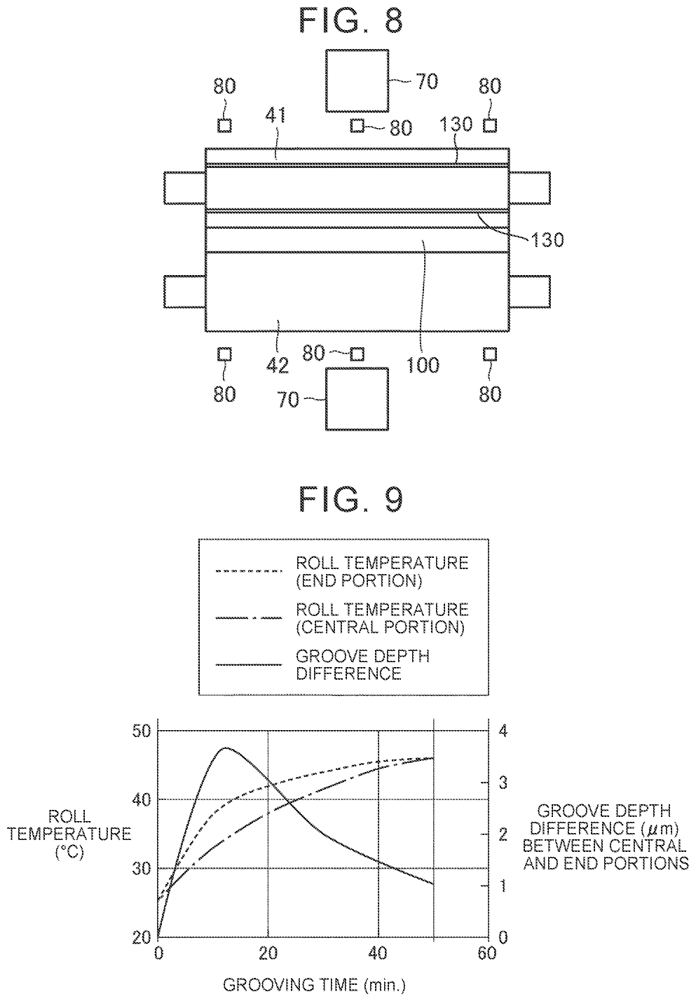

One or more protrusion molds are formed on the outer circumferential surface of the shaping roll 41. For example, in order to form the recesses 121 extending in the width direction of the electrode 100 over the entire length of the electrode layer 120 as shown in FIG. 3, protrusion molds 130 extending straight in the width direction of the shaping roll 41 are formed on the outer circumferential surface of the shaping roll 41, as shown in FIG. 7 and FIG. 8. Similarly, in order to form the groove-like recesses 121 extending in the short-side direction of the electrode 100 as shown in FIG. 1, protrusion molds (not shown) extending in the width direction and having the same width as the recesses 121 are formed on the outer circumferential surface of the shaping roll 41. The shaping device 40 forms the recesses 121 and the raised portions 122 in the surface of the electrode layer 120, by sandwiching the electrode 100 carried by the conveyor device 10 in the longitudinal direction (Y-direction) between the shaping roll 41 and the opposed roll 42, and pressing the protrusion molds of the shaping roll 41 against the surface of the electrode layer 120 at this time. The shaping device 40 is located on the upstream side of the drying device 50 in the conveying direction of the electrode 100, and is arranged to process the surface of the electrode layer 120 that is in a wet state before drying. This makes it easy to form the uneven shape.

When the recesses and raised portions extending in the longitudinal direction of the electrode 100 and the recesses and raised portions extending in the short-side direction are both formed in the electrode layer 120, the shaping device 40 may have one shaping roll that forms both the recesses and raised portions extending in the longitudinal direction and the recesses and raised portions extending in the short-hand direction.

Alternatively, the shaping device 40 may have a shaping roll that forms the recesses and raised portions extending in the longitudinal direction of the electrode 100, and a shaping roll that forms the recesses and raised portions extending in the short-hand direction of the electrode 100, respectively.

The drying device 50 dries the electrode layer 120 after the recesses and raised portions are formed. The drying device 50 can dry the electrode layer 120 by any given method. For example, the drying device 50 may include a hot air dryer, an infrared dryer, etc. Drying conditions (drying temperature, drying time, etc.) in the drying device 50 are adjusted so that the electrode layer 120 is brought into a dry state.

After the electrode layer 120 is dried, the electrode 100 is cut to a predetermined size using, for example, a slitter, to produce a sheet-like electrode 100 as shown in FIG. 1 to FIG. 3.

### Film Forming Device 20

In the film forming device 20, the electrode material is supplied between a pair of rolls that are arranged in parallel with each other with a spacing therebetween and are respectively driven to be rotated, and the electrode material is compressed and formed by the pair of rolls to form a sheet-like coating film.

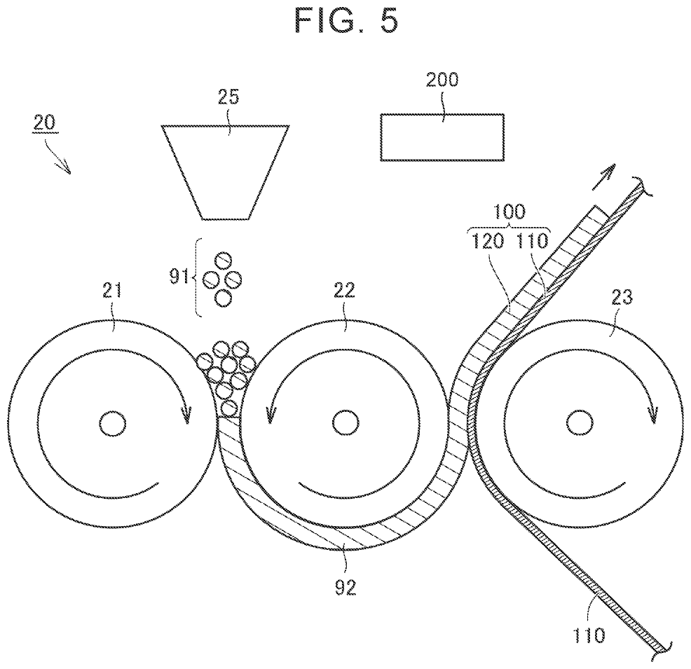

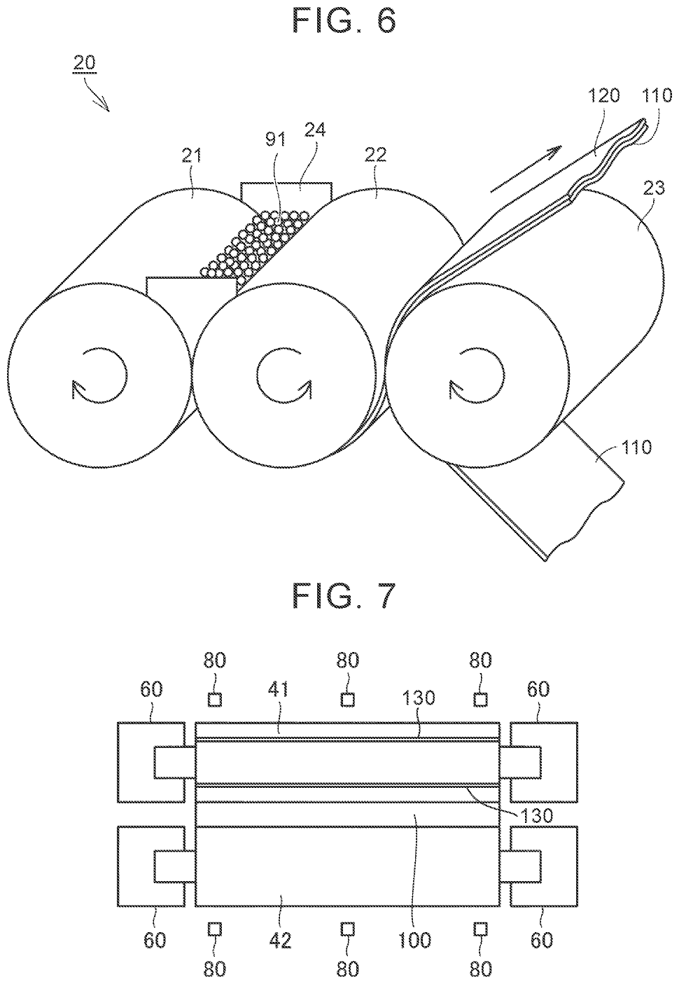

FIG. 5 is a conceptual diagram showing details of the configuration of the film forming device 20. FIG. 6 is a conceptual perspective view showing details of the configuration of the film forming device 20. As shown in FIG. 5 and FIG. 6, the film forming device 20 has a first roll 21, second roll 22, and third roll 23. The first roll 21, second roll 22, and third roll 23 have a generally cylindrical shape having substantially the same diameter.

The first roll 21, second roll 22, and third roll 23 are respectively driven to be rotated. In FIG. 5 and FIG. 6, a curved arrow depicted in each roll indicates the rotational direction of the roll. The second roll 22 rotates in the opposite direction of the first roll 21. The third roll 23 rotates in the opposite direction of the second roll 22. In FIG. 5 and FIG. 6, the first roll 21 rotates in the clockwise direction, the second roll 22 rotates in the counterclockwise direction, and the third roll 23 rotates in the clockwise direction.

The second roll 22 is spaced apart from and arranged in parallel with the first roll 21. The outer circumferential surfaces of the first roll 21 and the second roll 22 are opposed to each other via a first gap, which is a gap between the first roll 21 and the second roll 22. The axes of the first roll 21 and the second roll 22 are fixed so that the distance between these rolls is kept constant.

The third roll 23 is spaced apart from and arranged in parallel with the second roll 22. The outer circumferential surfaces of the second roll 22 and the third roll 23 are opposed to each other via a second gap, which is a gap between the second roll 22 and the third roll 23. The axis of the third roll 23 is fixed so that the distance between the third roll 23 and the second roll 22 is kept constant.

A feeder 25 is located right above the first gap between a pair of rolls, specifically, between the first roll 21 and the second roll 22. The feeder 25 supplies electrode material 91 to the first gap between the first roll 21 and the second roll 22. The electrode material 91 is, for example, powder.

As shown in FIG. 6, the film forming device 20 further has a pair of partition walls 24. The partition walls 24 are arranged in parallel with each other, with a given spacing in the axial direction of each roll. The partition walls 24 put a limit to the width dimension of the electrode material 91 supplied to the gap between the first roll 21 and the second roll 22.

As the first roll 21 and the second roll 22 rotate, the electrode material 91 passes through the first gap between the first roll 21 and the second roll 22, and is drawn downward of the first gap. The electrode material 91 is consolidated (compressed) and formed into a sheet as it passes through the first gap between the first roll 21 and the second roll 22. In this manner, a thin coating film 92 is formed from the electrode material 91. By changing the dimensions of the first gap between the first roll 21 and the second roll 22, it is possible to adjust the thickness of the coating film 92 and the mass per unit area of the coating film 92.

After passing through the first gap between the first roll 21 and the second roll 22, the coating film 92 is conveyed while adhering to the second roll 22, and fed to the second gap between the second roll 22 and the third roll 23.

The substrate 110 is conveyed to the third roll 23 after it is rolled out from the feed roll 11 (FIG. 4). The substrate 110 is conveyed on the third roll 23, and fed to the second gap between the second roll 22 and the third roll 23.

The coating film 92 and the substrate 110 are supplied between the second roll 22 and the third roll 23. In the second gap, the coating film 92 is pressed against the substrate 110, and the coating film 92 is pressed onto the surface of the substrate 110, away from the second roll 22. Namely, the coating film 92 is transferred from the second roll 22 to the substrate 110. In this manner, the electrode 100 is formed in which the sheet-like electrode layer 120 is laminated at a predetermined position on the surface of the substrate 110. The second roll 22 and the third roll 23 constitute a pair of rolls that rotate in opposite directions while sandwiching the electrode 100 therebetween.

Since the film forming device 20 has the pair of partition walls 24, which put a limit to the width dimension of the electrode layer 120, the electrode 100 is provided with exposed portions (see FIG. 1 to FIG. 3) on which the electrode layer 120 is not formed, on the opposite sides of the electrode layer 120 in the width direction (X-direction) of the electrode 100. The recesses 121 shown in FIG. 3 communicate with the exposed portions on the opposite sides of the electrode layer 120.

In the example shown in FIG. 5 and FIG. 6, the first roll 21, second roll 22, and third roll 23 are arranged side by side, and the rotation axes of the first roll 21, second roll 22, and third roll 23 are on the same plane. The first roll 21, second roll 22, and third roll 23 are not limited to those of the example shown in FIG. 5 and FIG. 6, but may be located as desired. For example, the third roll 23 may be located right below the second roll 22 with a spacing between the third roll 23 and the second roll 22.

### Temperature Adjusting Unit

The electrode manufacturing apparatus 1 of the embodiment further has a temperature adjusting unit. The temperature adjusting unit has the function of reducing a temperature difference between a central portion and an end portion in the axial direction, of at least one roll of the pair of rolls (i.e., the shaping roll 41 and the opposed roll 42) that rotate in opposite directions while sandwiching the electrode 100 therebetween in the shaping device 40.

FIG. 7 is a schematic view showing a first example of the temperature adjusting unit. The temperature adjusting unit shown in FIG. 7 adjusts the temperature of the shaping roll 41, and adjusts the temperature of the opposed roll 42. More specifically, the temperature adjusting unit has cooling devices 60. The cooling devices 60 cool the opposite end portions of the shaping roll 41. The cooling devices 60 cool the opposite end portions of the opposed roll 42.

The cooling device 60 is realized, for example, by a flow channel of cooling medium formed in a housing that supports the end portions of the rolls. The cooling medium is, for example, water. The housing rotatably supports the end portions of the rolls via bearings. The flow channels of the cooling medium are formed around the bearings, and the cooling medium circulates in the flow channels. The cooling medium of which the temperature was increased by heat transferred from the end portion of the roll is cooled at a position away from the end portion of the roll, and returns to the end portion of the roll. The cooling device 60 is not limited to this example, but may cool the end portion of the roll by any means, for example, a Peltier element, heat pipe, etc.

FIG. 8 is a schematic view showing a second example of the temperature adjusting unit. The temperature adjusting unit shown in FIG. 8 adjusts the temperature of the shaping roll 41 and adjusts the temperature of the opposed roll 42. More specifically, the temperature adjusting unit has heating devices 70. The heating device 70 heats the central portion of the shaping roll 41. The heating device 70 heats the central portion of the opposed roll 42.

The heating device 70 is realized, for example, by an electric heater. The heating device 70 may have two or more heaters arranged in the axial direction of the roll. Which one or ones of the two or more heaters are caused to generate heat, or the amount of heat generated by the heater or heaters, may be controlled according to the temperature distribution of the roll in the axial direction.

As shown in FIG. 7 and FIG. 8, the shaping device 40 further has temperature sensors 80. The temperature sensor 80 may be a non-contact sensor, such as an infrared sensor. The temperature sensor 80 that detects the temperature of the central portion of the roll and the temperature sensors 80 that detect the temperatures of the end portions of the roll may be provided. The temperature sensor 80 that scans in the axial direction may detect the temperatures of the central portion and end portions of the roll. A controller 200 (see FIG. 4) obtains the detection results of the temperature sensors 80. A temperature difference between the central portion and the end portions of the roll is obtained from the detection results of the temperature sensors 80. The controller 200 performs feedback control on the temperature adjusting unit based on the temperature difference between the central portion and the end portions of the roll, so that the temperature adjusting unit can efficiently reduce the temperature difference between the central portion and the end portions of the roll.

### Operation and Effects

The characteristic configuration and effects of the above embodiment will be summarized and described as follows.

As shown in FIG. 4, the electrode manufacturing apparatus 1 includes the shaping device 40. The shaping device 40 has the shaping roll 41 that forms the recesses and raised portions in the surface of the electrode layer 120, and the opposed roll 42 that is opposed to the shaping roll 41 with the electrode 100 sandwiched therebetween. The shaping roll 41 and the opposed roll 42 rotate in opposite directions while sandwiching the electrode 100 therebetween. As shown in FIG. 7 and FIG. 8, the electrode manufacturing apparatus 1 has the temperature adjusting unit that reduces the temperature difference between the central portion and the end portions in the axial direction, of at least one roll of the shaping roll 41 and the opposed roll 42.

The end portions of the roll are supported by the housing. When the roll rotates relative to the housing, friction heat is generated. The friction heat is transferred to the roll, and the temperature at the end portions of the roll is more likely to rise to be higher than at the central portion of the roll. Where wide electrodes 100 are manufactured, the temperature difference between the central portion and the end portions of the roll may become significantly large, and the thermal expansion of the end portions of the roll may become larger than that of the central portion of the roll due to the influence of the temperature difference. The diameters of the end portions of the roll become larger than that of the central portion, and the gap between the pair of opposed rolls in the central portion of the roll is broadened. As a result, the grooving pressure is weakened at the central portion of the roll, and the depth of the recesses 121 (grooves) formed in the electrode layer 120 is reduced. Consequently, the uniformity of the groove depth of the electrode layer 120 between the central portion and the end portions in the width direction of the electrode 100 may not be maintained.

In the electrode manufacturing apparatus 1 of the embodiment, the shaping device 40 has the temperature adjusting unit, which is configured to reduce the temperature difference between the central portion and the end portions of the roll. The uniformity of the thermal expansion between the central portion and the end portions of the roll can be improved, and the uniformity of the outside diameter of the roll between the central portion and the end portions of the roll can be improved. Accordingly, the electrode manufacturing apparatus 1 of the embodiment can maintain the uniformity of the groove depth of the electrode layer 120 in the width direction even when wide electrodes 100 are manufactured.

As shown in FIG. 1 and FIG. 3, the shaping roll 41 may form the groove-like recesses 121 extending in the width direction of the electrode 100, in the surface of the electrode layer 120. In the case where the thickness of the electrode layer 120 is equal to or larger than a given value, cracks may appear in the electrode layer 120 when the electrode 100 passes over a roll with a large hugging angle during conveyance of the electrode 100. The recesses 121 extending in the short-side direction of the electrode 100 are formed in the electrode layer 120, to give the flexibility to the electrode 100, so that cracking of the electrode layer 120 during conveyance of the electrode 100 can be curbed, and the conveyability of the electrode 100 is improved.

As shown in FIG. 3, the shaping roll 41 may form the recesses 121 extending over the entire length of the electrode layer 120 in the width direction. The recesses 121 communicate with the opposite edges of the electrode layer 120 in the width direction, and the recesses 121 communicate with the opposite exposed portions in the width direction of the electrode layer 120. Since the liquid can flow in the recesses 121, the penetration time in the subsequent electrolyte injection process can be reduced. Thus, the productivity of batteries using the electrodes 100 can be improved.

As shown in FIG. 7 and FIG. 8, the temperature adjusting unit may adjust the temperature of the opposed roll 42. The load applied to the shaping roll 41 may vary depending on the relationship between the shape of the protrusion mold of the shaping roll 41 and the depth of the recess 121 formed in the electrode layer 120. On the other hand, the load applied to the opposed roll 42 is kept relatively constant, irrespective of the relationship between the shape of the protrusion mold of the shaping roll 41 and the depth of the recess 121 formed in the electrode layer 120. Therefore, it is possible to efficiently maintain the uniformity of the groove depth of the electrode layer 120, by adjusting the temperature of the opposed roll 42 and improving the uniformity of the outside diameter between the central portion and the end portions of the opposed roll 42.

By providing both the shaping roll 41 and the opposed roll 42 that constitute the shaping device 40 with the temperature adjusting units, as shown in FIG. 7 and FIG. 8, the uniformity of the groove depth of the electrode layer 120 can be further improved.

As shown in FIG. 7, the temperature adjusting unit may have the cooling devices 60 for cooling the end portions of the rolls. The cooling devices 60 cool the end portions of the roll, so that the temperature difference between the central portion and the end portions of the roll can be reliably reduced. The shaping device 40 is located upstream of the drying device 50 for drying the electrode layer 120 in the conveying direction of the electrode 100, and the electrode layer 120 is in a wet state before drying when it passes through the shaping device 40. When the roll is heated, the water in the electrode layer 120 evaporates faster, and the moisture content of the electrode layer 120 may be reduced, thus making it difficult to handle the electrode layer 120. When the end portions of the roll are cooled to adjust the temperature of the roll, the water in the electrode layer 120 is less likely or unlikely to evaporate, and changes in the properties of the electrode 100 due to changes in the moisture content of the electrode 100 can be reduced.

As shown in FIG. 8, the temperature adjusting unit may have the heating devices 70 for heating the central portions of the rolls. The heating device 70 heats the central portion of the roll, so that the temperature difference between the central portion and the end portions of the roll can be reliably reduced. By controlling the amount of heat generated by the heating device 70, the temperature difference between the central portion and the end portions of the roll can be precisely reduced. When the heating device 70 consists of two or more heaters arranged in the axial direction of the roll, and the two or more heaters are controlled according to the temperature distribution in the axial direction of the roll, the temperature difference between the central portion and the end portions of the roll can be further reduced.

As shown in FIG. 7 and FIG. 8, the shaping device 40 may have the temperature sensors 80 for detecting the temperatures of the central portions and the end portions of the rolls. By feedback controlling the temperature adjusting unit based on the temperature difference between the central portion and the end portions of each roll, the temperature adjusting unit can efficiently reduce the temperature difference between the central portion and the end portions of the roll.

In the description of the embodiment, the example in which the temperature adjusting unit has the cooling devices 60 is shown in FIG. 7, and the example in which the temperature adjusting unit has the heating devices 70 is shown in FIG. 8. The temperature adjusting unit may have both the cooling devices 60 and the heating devices 70.

While the shaping device 40 has the temperature sensors 80 in the examples of FIG. 7 and FIG. 8, the temperature sensors 80 may not necessarily be provided. For example, by verifying in advance how the temperature of the roll varies according to grooving conditions, and controlling the temperature adjusting unit according to a program created based on the verification result to reduce the temperature difference between the central portion and the end portions of the roll, it is possible to similarly achieve the effects of the above embodiment.

An example will be described. By using the shaping device 40 equipped with the temperature adjusting unit, as described above in the embodiment, the recesses 121 were formed in the surface of the electrode layer. The roll temperature during grooving and the difference in the groove depth between the central portion and the end portions of the roll were measured. As a comparative example, shaping was performed in a similar manner, using a shaping device that is not equipped with the temperature adjusting unit, and the roll temperature during grooving and the difference in the groove depth were measured.

FIG. 9 is a graph showing the temperature difference between the central portion and the end portions of the roll and the groove depth difference in the comparative example. In the comparative example, a temperature difference appeared between the central portion and the end portions of the roll after a lapse of 10 min. from the start of grooving. The outside diameter of the end portions of the roll became larger than the outside diameter of the central portion due to thermal expansion. As a result, the groove depth difference between the central portion and the end portions exceeded 3 μm, and the uniformity of the groove depth of the electrode 100 could not be maintained.

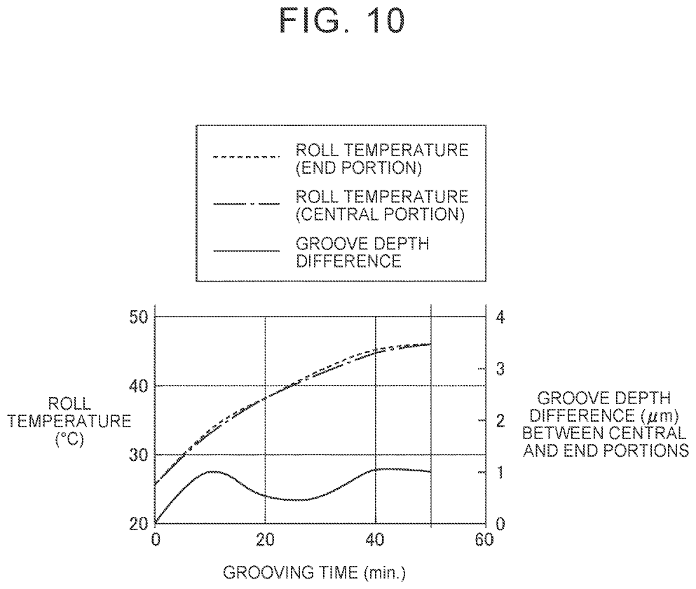

FIG. 10 is a graph showing the temperature difference between the central portion and the end portions of the roll and the groove depth difference, in the example of the embodiment. In the example, the temperature difference between the central portion and the end portions of the roll during the temperature increase was smaller than that of the comparative example. The difference in the outside diameter between the central portion and the end portions of the roll was reduced; as a result, the maximum difference in the groove depth between the central portion and the end portions was kept at about 1 μm. Accordingly, it became apparent that the uniformity of the groove depth of the electrode 100 can be maintained by reducing the temperature difference between the central portion and the end portions of the roll.

It is to be understood that the embodiment disclosed herein is exemplary in all respects, and is not restrictive. The scope of this disclosure is indicated by the claims, rather than the above description, and is intended to include all changes within the claims and the meaning and range of equivalents thereof

What is claimed is:

1. An electrode manufacturing apparatus comprising:
a pair of rolls that sandwich an electrode and rotate in opposite directions; and
a temperature adjusting unit configured to reduce a temperature difference between a central portion and an end portion in an axial direction, of at least one roll of the pair of rolls.

2. The electrode manufacturing apparatus according to claim 1, wherein:
the electrode has a substrate and an electrode layer formed on a surface of the substrate; and
the pair of rolls have a shaping roll configured to form an uneven shape on a surface of the electrode layer, and an opposed roll that is opposed to the shaping roll such that the electrode is sandwiched between the shaping roll and the opposed roll.

3. The electrode manufacturing apparatus according to claim 2, wherein the shaping roll is configured to form recesses in a form of grooves extending in a width direction of the electrode, in the surface of the electrode layer.

4. The electrode manufacturing apparatus according to claim 3, wherein the shaping roll is configured to form the recesses extending over an entire length of the electrode layer in the width direction.

5. The electrode manufacturing apparatus according to claim 1, wherein the pair of rolls have a shaping roll having one or more protrusion molds on an outer surface, at positions corresponding to positions at which recesses are to be formed in a surface of an electrode layer of the electrode, and an opposed roll that is opposed to the shaping roll such that the electrode is sandwiched between the shaping roll and the opposed roll.

6. The electrode manufacturing apparatus according to claim 2, wherein the temperature adjusting unit is configured to adjust a temperature of the opposed roll.

7. The electrode manufacturing apparatus according to claim 1, wherein the temperature adjusting unit has a cooling device that cools the end portion.

8. The electrode manufacturing apparatus according to claim 1, wherein the temperature adjusting unit has a heating device that heats the central portion.

9. The electrode manufacturing apparatus according to claim 1, further comprising temperature sensors that detect a temperature of the central portion and the temperature of the end portion.

10. The electrode manufacturing apparatus according to claim 9, further comprising a controller configured to perform feedback control on the temperature adjusting unit, based on a difference between the temperature of the central portion and the temperature of the end portion detected by the temperature sensors.
